(19) United States
(12) Patent Application Publication
(10) Pub. No.: US 2014/0156055 A1
(43) Pub. Date: Jun. 5, 2014

(54) AUTOMATED CONTROL SYSTEM FOR ACTING ON AN ASSEMBLY OF FUNCTIONAL BLOCKS IN ORDER TO CARRY OUT AT LEAST ONE TASK

(71) Applicant: Jean-Luc Bettiol, (US)

(72) Inventor: Jacques DESROUSSEAUX, Saint Maximin la Sainte Baume (FR)

(73) Assignee: Jean-Luc BETTIOL, Marseille (FR)

(21) Appl. No.: 13/773,303

(22) Filed: Feb. 21, 2013

(30) Foreign Application Priority Data
Nov. 30, 2012 (FR) 1261495

(51) Int. Cl. G05B 11/01

(52) U.S. Cl. CPC G05B 11/01
USPC 700/162

(57) ABSTRACT

An automated system for acting on a set of blocks in order to carry out at least one task including a central control device, at least one shared data line, and interface circuits for connecting the blocks to the shared line. In one embodiment of the invention, the control device includes a PC computer on which is installed an operating software for determining the phases of operation of the blocks.

### FIELD OF THE INVENTION

This invention relates to an automated control system for acting on an assembly of at least one functional block in order to carry out at least one task.

### SUMMARY OF THE INVENTION

An automated control system according to an exemplary embodiment of the present invention includes:
a central control unit,
at least one shared data line,
interface circuits for connecting the blocks to at least one of the shared lines.

This type of system has important applications, particularly in the field of industrial processes used for manufacturing various parts or for the upkeep of machines requiring maintenance.

Such a system is described in patent document EP 0 278 802. This known system has a complex structure, and it is thought that there are major difficulties in perfecting the operation of said system.

This invention proposes a system of the type mentioned in the preamble, which, based on a structure of this type, makes it easy to define a proper operation of said system.

Such a system is noteworthy in that the control system is formed of a PC-type computer comprising memory cooperating with operating software in order to determine the phases of operation of said blocks. For the purposes of the present invention, the term “software” is defined as non-transitory computer readable media that stores instructions which are executable by one or more computer processors to carry out the various algorithms of the present invention.

“Blocks” are understood to mean elements on which the system is capable of acting, such as audible or visual alarms or hydraulic pumps, and from which it is capable of collecting information, such as water meters, electric meters, etc.

This type of system has important applications, particularly in the domain of industrial processes, automation, and data acquisition of all types. The system can be powered with 12 V_{CC} and can therefore be put on-board vehicles or boats or can operate at isolated sites.

### BRIEF DESCRIPTION OF THE DRAWINGS

The following description accompanied by the attached drawings, all provided as a non-limiting example, will make it clearly understood how the invention can be implemented. In the drawings:

FIG. 1 shows a diagram of a system conforming to the invention,

FIG. 2 shows an implementation example of a shared line appropriate for a system conforming to the invention,

FIG. 3 shows an embodiment of an interconnection box on the shared data line,

FIG. 4 shows a first embodiment of an interface circuit,

FIG. 5 shows a second embodiment of an interface circuit,

FIG. 6 shows a third embodiment of an interface circuit,

FIG. 7 shows a fourth embodiment of an interface circuit,

FIG. 8 shows an embodiment targeting an installation formed of industrial boilers,

FIG. 9 shows a block diagram detailing the organization of software usable by the invention.

In these figures, common elements are all labeled with the same references.

### DETAILED DESCRIPTION

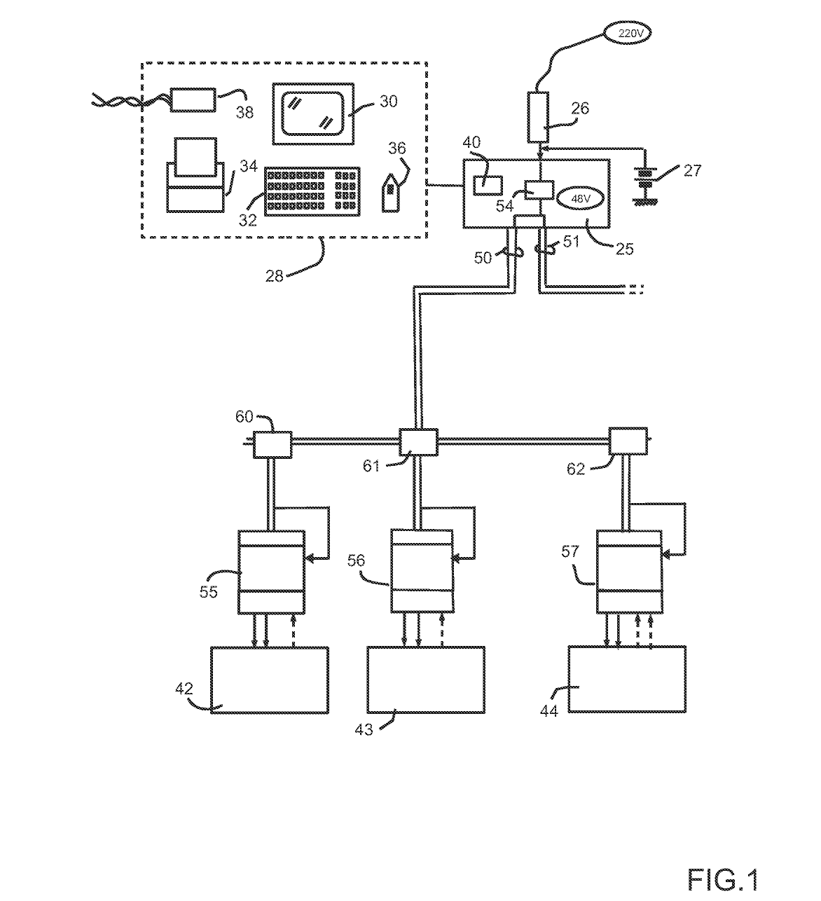

FIG. 1 shows a system conforming to the invention. The entire system is based on the use of an industrial PC computer (25). This computer 25 is powered by 12 volts of direct current, either from a commercial electric power supply 26 or from a battery 27 if the system is embedded.

Attached to this computer is a set of peripherals 28 consisting essentially of a screen 30, a keyboard 32, a printer 34, a mouse 36, and a modem 38 to allow an internet connection. This computer 25 works with a software suite installed in a program memory area 40.

The invention proposes different measures for connecting the computer 25 to the various functional blocks 42, 43 and 44 (for example thermometers, pressure gauges, solenoid valves, detectors, etc.). Indeed, communication must be provided between this computer 25 and these blocks for which the phases of operation are to be managed.

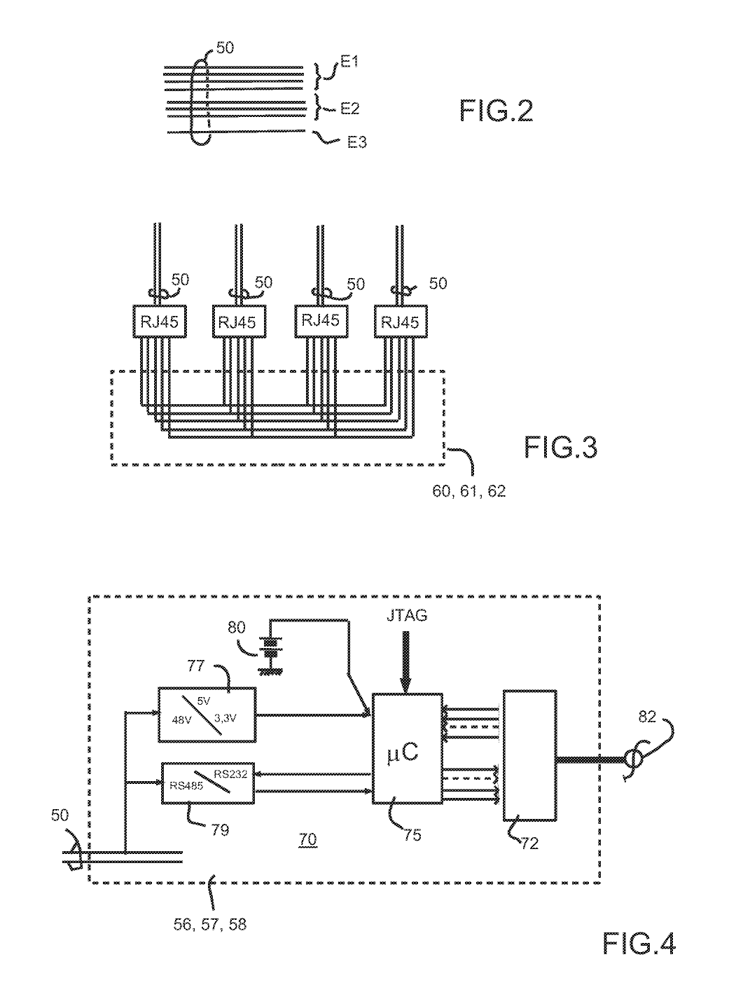

To do this, a first bus line 50 and a second line 51 connected to the computer 25 are provided. The structure of these lines is shown in FIG. 2. The line consists of eight wires. Of these eight wires, a set of four wires E1 is assigned to carry the supply voltage (48 V) in order to provide approximately 30 Watts of power, a set of three wires E2 is assigned to transmitting data in the two possible directions of transmission (RS485 standard), and one wire E3 is for sending an interrupt to different blocks. In practice, the connectors for these lines 50 and 51 are RJ45 connectors. In FIG. 1, a wire 53 schematically represents the application of a voltage to be supplied to these lines 50 and 51. Two pairs are used for an RS485 bus. The two other pairs are used to carry the 48 Vdc power obtained from a converter 54. Line 50 is connected to different interface circuits 55, 56 and 57, using interconnection boxes 60, 61 and 62. The structure of these interconnection boxes is shown in FIG. 3. They have a simple structure: the wires are directly connected to each other, as is clearly shown in FIG. 3. For clarity in the explanations, the interconnections with line 51 will not be discussed but are established in the same manner.

Thus one can see that the sole power to the system is what is enabled by the computer 25. Elements to be powered separately are peripheral computer-related elements, and blocks such as sensors or actuators if their consumption is too great to be powered by lines 50 and 51.

FIG. 4 shows the structure common to all the interfaces usable by the system from the invention, particularly circuits 55, 56 and 57. These interface circuits are formed from the same base circuit 70, with which adapted circuits 72 are associated. These adapted circuits 72 allow dialog with the functional blocks. The base circuit 70 essentially comprises: a microcontroller 75 which can be programmed by a program injected via its JTAG interface consisting of four accesses for lead wires; a set of converters 77 which, from the voltages carried by the line 50, provides the voltages required to power the various components of the interface circuit, for example voltages of 5 V_{CC} and 3.3 V_{CC}; and an RS485/RS232 protocol converter, denoted 79, which converts the signals from the bus 50 into signals compliant with the RS232 protocol in order for them to be accepted by the microcontroller 75. A backup battery 80 is provided which allows the microcontroller 75 to operate, particularly in order to back up certain important data, the state of the microcontroller memory, and also allow the possibility of executing indispensable functions in case of power loss. The microcontroller communicates with the computer 25 via an RS232 port. The presence of the RS485/RS232 converter, denoted 79, is justified for the following reason: an RS232 connection does not allow sending the signal for distances of more than 30 m at 9600 baud. The RS485 protocol tolerates much larger distances, which gives more flexibility when installing the system of the invention.

It should be noted that each interface circuit is assigned an address, thus from the PC 25 one can define which functions are applicable to the various inputs and outputs.

Each interface card comprises, in addition to the base circuit 70, an adapted circuit 72 as mentioned above, so that the blocks attached to the accesses 82 can be read or acted upon. This adapted circuit can of course be different for each interface circuit, depending on what the external blocks are.

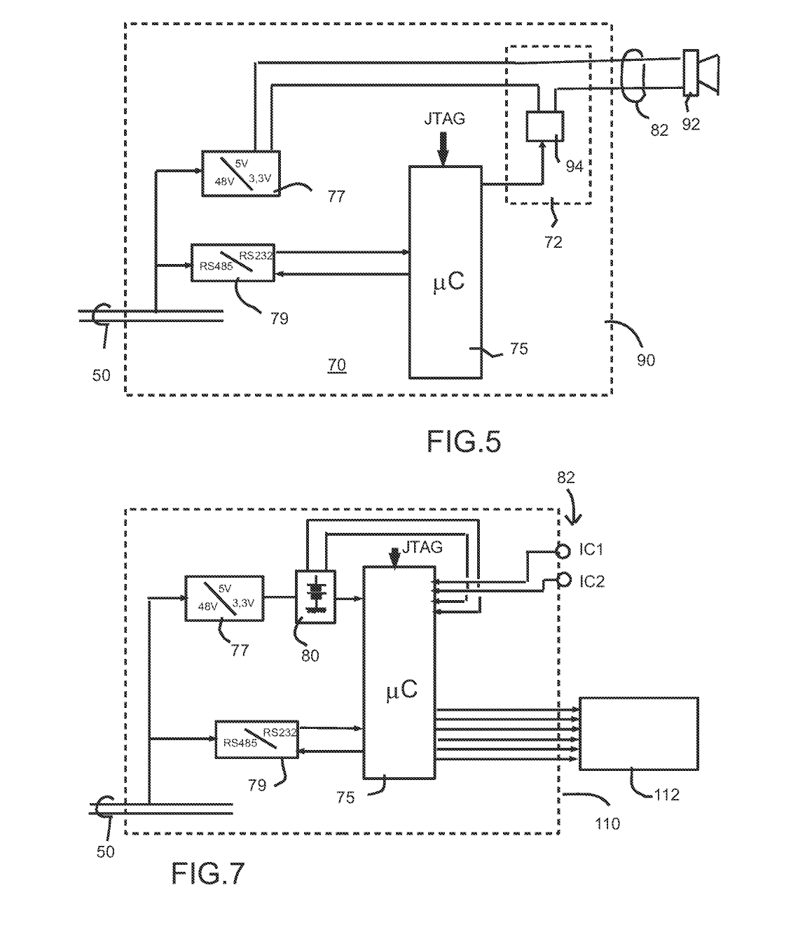

An example of an interface circuit 90 is shown in FIG. 5. Its purpose is to activate a warning device in order to notify a user of an anomaly such as an alarm, abnormal operation, or any other emergency. A siren, flashing light, or flash lamp is used. In the example described below, a flash lamp with a siren was chosen, powered at 12 to 24 volts and only consuming 1.5 watts. The bus lines 50 or 51 can deliver sufficient power to operate the siren. The interface card shown in this figure can be sufficiently small for inclusion inside the siren housing. The converter 77 must generate a supplemental voltage of 24 Vdc in order to power the siren. An optocoupler 94 allows sending the voltage to the siren when the connected output is activated. The firmware allows for receiving a generic command. In this case, the microcontroller 75 does not respond. This is the only case where multiple interface circuits can be connected on the same shared line and have the same address without disruption. Several sirens can therefore be connected on the same line with the same configuration and be added at any point on the line. In this manner, the alarm signals can be heard or seen at multiple locations.

Of course, this same type of card has other applications. For example, it becomes possible to convert, for example, an existing analog sensor into a digital sensor and supply power to it. This eliminates the transmission and power constraints of the sensor and often increases its performance if the transmission interferes with the signal.

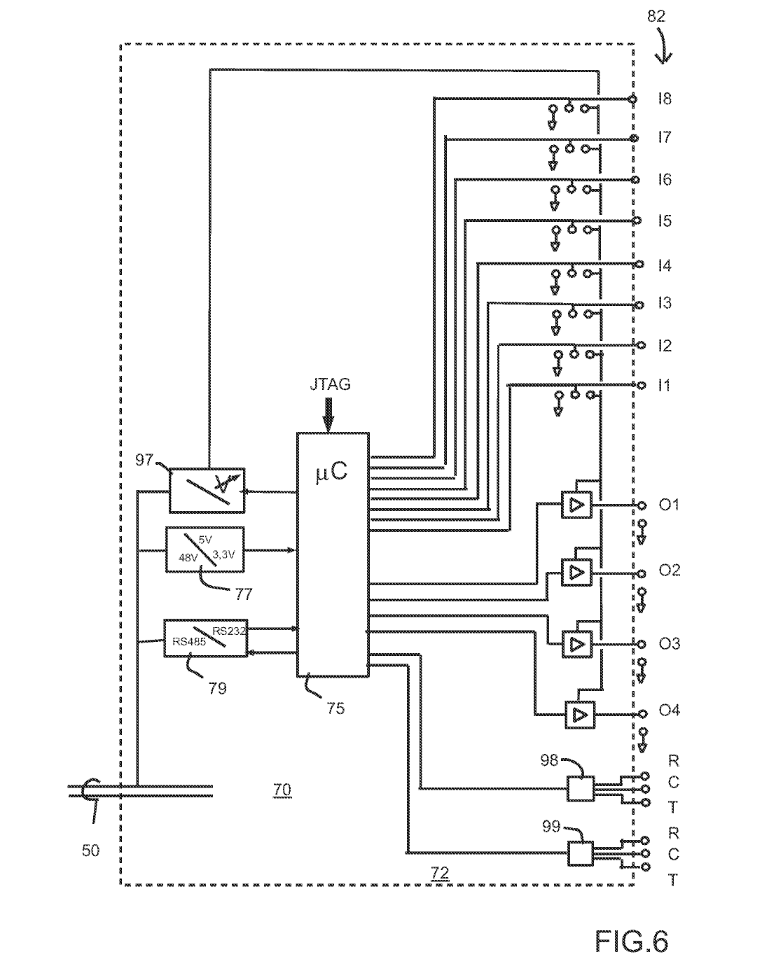

Another example of an interface circuit is shown in FIG. 6. This interface circuit, denoted 95, has a more complex structure than the ones presented above. The elements common to those in the above figures are labeled with the same references.

In many fields, including the sector of industrial automation, a need for interface circuits comprising a large number of inputs and outputs is becoming apparent. The principle of the invention is to arrange the interface circuits as close as possible to the blocks containing elements to be read or controlled, in order to minimize wiring costs. When multiple elements are close by, a particularly interesting application of the interface circuit 95 described above is found. In addition to the common elements of the interface circuits already described, an adjustable power supply 97 controlled by the microcontroller has been added. This allows adapting the interface to the voltage used by the external elements. The voltage in industrial applications can be 24 volts but, depending on the case, could also be 12 volts or some other voltage. Eight inputs are available, labeled I1 to I8. For each input, a connector with three pins for the ground, the input, and the adjustable voltage allows connecting a sensor, while also providing power to it if necessary. Electronics, not represented here, must of course be added to protect the microcontroller. As for the outputs, two types of wiring have been used on the card. The outputs O1, O2, O3, O4 do not deliver any voltage if they are not activated, and deliver the adjustable voltage if they are. The two other outputs 98, 99 are relay contacts controlled by the microcontroller. If the output is not active the contacts C and R are short-circuited, and if the output is active the contacts C and T are short-circuited. The relays allow direct use with 230 volt commercial power supply for a power of less than 1000 Watts. They can also serve to control power relays for greater power levels or three-phase power.

This interface circuit realized in card form is, of course, much larger and more costly than the previous circuit. If a card is to be integrated into an assembly, designing a derived card specifically adapted for a product or system remains possible.

Yet another example is shown in FIG. 7.

The interface circuit which is shown in FIG. 7 is labeled 110. A preferred field of use for this circuit is meter reading. Some meters can be read electrically by the RS485 bus but others are mechanical. Such is the case for most water and gas meters. The manufacturers of this type of meter offer two possibilities for reading the meter: either an electronic meter with remote reporting (in this case, however, the reading software is proprietary and the readings can only be done by the manufacturer or an authorized company) or by adding a pulse generator to the meter.

In one embodiment of the invention, it was decided to use meters with pulse generators. To be able to verify the status of the meters and compare them with the value from mechanical meters, a display 112 with two rows of 16 characters was added, which thus allowed displaying two meters from which pulses are received on the respective terminals IC1 and IC2 of the access 82. A backup battery 80 is indispensable here, to allow the microcontroller to save the state of the internal meters and for it even to be able to add pulses if they arrive. In fact, if the bus line 50 no longer supplies power, the meters must remain active because water or gas consumption is independent. Two other microcontroller inputs are used. One is to notify the microcontroller when changing from power supplied by the line 50 to power supplied by the battery 80 so that it switches to power saving mode; the other is for measuring the power in the battery so that the computer 25 can warn the user to replace the battery before it has completely discharged. The internal meters must be initialized to the same value as the value from the electromechanical meters.

Certain electric meters for distribution panels also comprise a pulse generator. It is possible to use them with the same interface card, for example when wanting to read the consumption for a defined group of devices in order to determine the cost of using them. If the computer can be informed of EDF [Électricité de France] time slots and electricity rates it will be possible to apportion the consumption in order have a more precise view of the specific cost of using the devices.

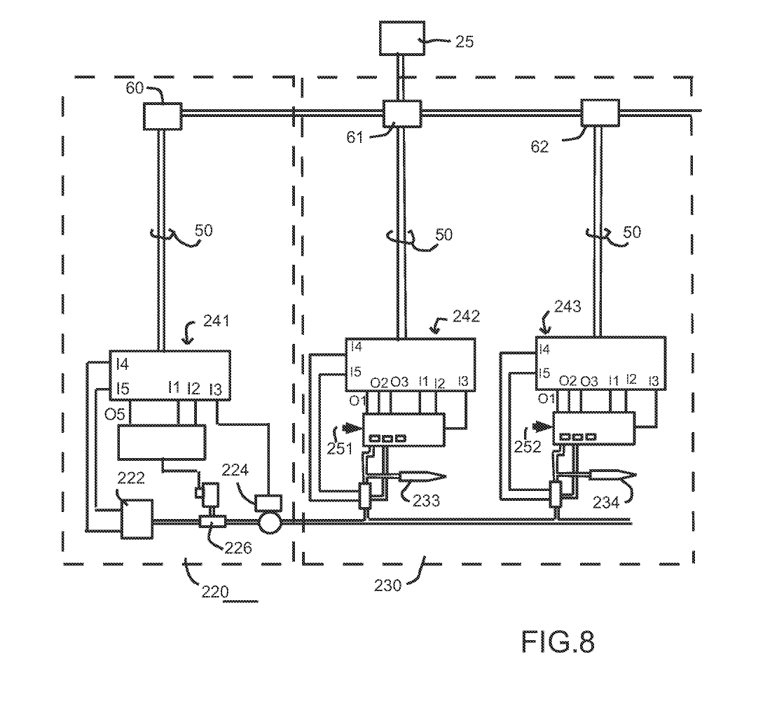

FIG. 8 shows an example of applying a system of the invention to a context from the industrial automation domain, specifically the production of collective electricity or heating in a town. To do this, very large boilers are used. They are fed coal or heavy fuel oil or may be within an incineration plant. A shutdown for maintenance is very costly and can last up to a week. Two or three days are required for the furnace to cool down, plus the same amount of time for the temperature to climb back up. The tubes in which the energy recovery water circulates are rapidly coated with ash from the combustion. The yield from the boiler is reduced accordingly. Boiler tube cleaning must therefore take place during production periods.

To do this, one of the solutions is to periodically project a jet of aqueous chemical solution onto the tubes using one or more nozzles.

FIG. 8 represents the facility comprising, in the storage area 220, the tank of product 222 with the pump 224 and the flow meter 226 which indicates the volume of product pumped in order to stop the pump at the proper moment. In the energy recovery area 230, there are two fixed nozzles 233 and 234 facing the tubes.

In this embodiment, three interface circuits 241, 242, and 243 are used. These are circuits of the type already shown in FIG. 6. One of the interface circuits 241 is located close to the pump in the storage area 220. The two others 242 and 243 are each located near each nozzle. The distances between each interface circuit and the computer 25 are great and may reach more than 100 m. In the prior art techniques, the automation occurred using a programmable logic controller (PLC) with all the outputs from this PLC attached in a panel stored in the storage area. The wiring required one cable per nozzle, with large cross-section conductors threaded throughout the entire company. With the measures recommended by the invention, one obtains the advantage of a significant decrease in the installation cost and displaying the operation of the automation from a clean zone far from the storage area.

The first interface circuit 241 is located near the pump 224 and the tank 222 in an electrical cabinet; the output O5 (relay output) controls the three-phase relay of the pump. Inputs I1 and I2 allow one to see whether the relay is stuck and that the overload circuit breaker for the pump has not been triggered. If this circuit breaker is triggered, it means that the line is clogged. Input I3 powers the flow meter and collects the pulses, which are counted in a meter internal to the microcontroller. When an injection is initiated, the computer sends the number of pulses corresponding to the volume to be injected, resets the meter, and then activates output O5. The microcontroller of the interface card 241 stops the pump 224 by deactivating O5 when the meter reaches the pre-established value. The inputs I4 and I5 make it possible to know the status of the level in the tank because the pump cannot operate when empty.

The two other interface circuits 242 and 243 are each mounted in the same manner on the nozzles 233 and 234. The nozzles are managed by compressed air controls respectively available on accesses 250 and 251. Output O1 activates the passage of air for cooling before injection and purging after injection. Output O2 activates an air solenoid valve which serves to open the solenoid valve for the product. Output O3 serves to operate a cylinder to advance the nozzle when it is movable. Inputs I1 and I2 receive information concerning the presence of compressed air and of the compressed air released which is necessary for purging the nozzle. Inputs I4 and I5 receive the limit switch contacts of the product valve so that the computer can verify that the valve is properly opened or closed.

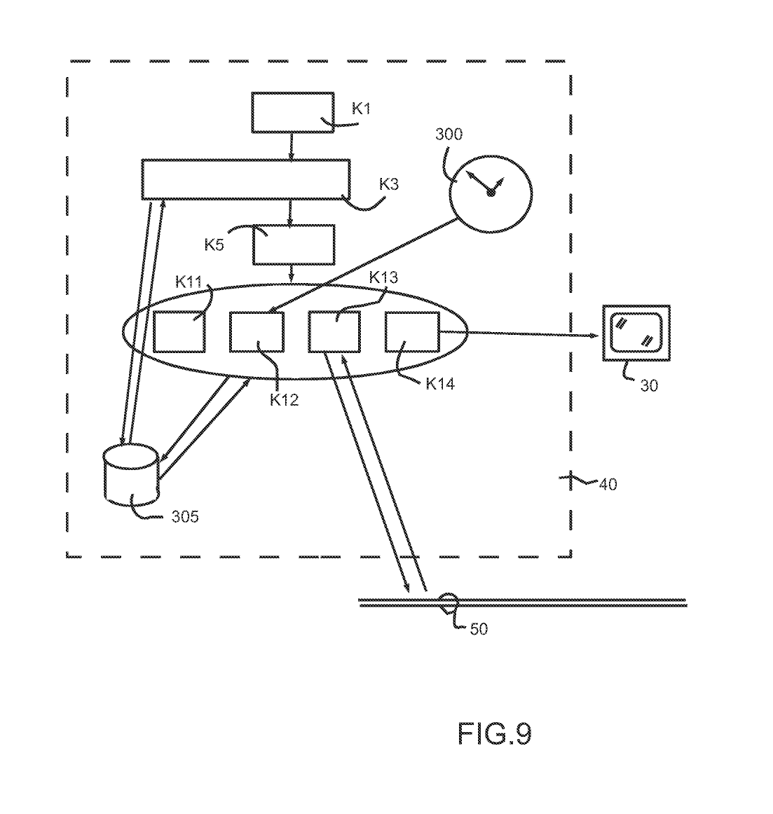

FIG. 9 shows the organization of the software implemented in the memory 40 of the computer 25. This organization makes use of the system clock 300 of the computer 25 and of its mass storage 305. The screen 30 also contributes. Other computer components may also be used.

The software is a complete development environment for automation and data acquisition, particularly software usable with the system of the invention. This same set of software is used to run the application at the client.

To run this software suite, the path and filename containing the list of files to be interpreted are provided as arguments.

Therefore it first loads and analyzes the set of files concerned. This is illustrated by box K1.

After this analysis, the set of variables and actions is created as well as the windows for the screens and the automations, which are determined by analyzing the developed “sequential function charts” in order to define the various actions to be performed with the functional blocks (see box K5). These various phases are shown in boxes K11, K12, K13 and K14, respectively representing the automations, variables, actions, and screens to be developed.

Lastly, one runs the application that allows the created elements to interact with each other and with the mass storage 305 (for reading or writing files) and the bus lines, line 50 (for communicating with the various interface circuits involved in the automations to be managed).

### EXAMPLE

The pressing of an on-screen button can trigger an operation which changes the value of a variable. The change in the value of the variable can make the start condition true for an automation. The automation can trigger a dialog with an interface circuit via the line 50. This dialog can change the value of a variable which is displayed. In the variable declaration, it can be requested that the variable be saved in mass storage so that it can take-on the last known value if the program is restarted. Such an event may occur when there is a power outage, for example. In this case, the file containing the value of the variable will be modified. The screen will also be modified and will display the new variable value.

Everything that refers to the time (stopping an automation for a given time, starting time for an automation, etc.) uses the internal clock 300 of the PC. This allows scheduling times ranging from milliseconds to years without requiring any additional equipment.

To use the software to create an application, it is imperative that a file describing a screen include a file editor and a debugging screen. A button which performs a complete restart of the software can be present on these screens and allow a restart in less than ten seconds if the developer wants to see how a change in the files affects the operation.

1. Automated control system for acting on an assembly of at least one functional block in order to carry out at least one task, comprising:
a central control unit;
at least one shared data line;
interface circuits for connecting the blocks to at least one of the shared lines, wherein the control device comprises a PC computer comprising a memory cooperating with operating software in order to determine the phases of operation of said blocks; and
monitoring software for providing values to the PC on which the system acts.

2. Automated system according to claim 1, wherein the operating software is arranged to interpret “sequential function chart” files.

3. Automated system according to claim 1, wherein the line is of type RS485 to which a power source is added.

4. Automated system according to claim 1, further comprising interface circuits connected between the shared data line and the functional blocks to be controlled and a microcontroller.

5. Automated system according to claim 1, wherein the system can be supplied a voltage of 12 volts convertible to 24 volts in order to be embedded in vehicles or boats or be able to operate at isolated sites.

6. Automated system according to claim 1, further comprising a power source supplying energy to the different interface circuits connected to said line.

7. Automated system according to claim 4, wherein at least one piece of firmware intended for the microcontrollers of said interface circuits is loaded by the “jtag” pins of these microcontrollers.

8. Automated system according to claim 7, wherein the interface circuits comprise a base circuit and a circuit adapted to the block to be controlled.

9. Automated system according to claim 4, wherein an address is assigned to the interface circuits from the central control device.

10. Automated system according to a claim 4, further comprising a plurality of functional blocks intended to supply alarm signals, wherein interface circuits attached to alarm signal blocks are assigned the same address.

11. Automated system according to claim 4, wherein the base circuit is formed of said microcontroller, a protocol converter between the data sent by the bus and the data processable by said controller, and a voltage converter for supplying the appropriate voltages to said blocks from the power provided by said shared line.

12. Automated system according to claim 4, wherein a backup battery is provided for the interface circuits.

13. Automated control system for acting on an assembly of at least one functional block (42, 43, 44) in order to carry out at least one task, comprising:
a central control unit (25, 27)
at least one shared data line (50,51),
interface circuits (55, 56, 57) for connecting the blocks to at least one of the shared lines, wherein the control device comprises a PC computer comprising a memory (40) cooperating with computer-readable media (170) that stores instructions which are executable by one or more processors to determine the phases of operation of said blocks,
monitoring computer-readable media (180) that stores instructions which are executable by one or more processors for providing values to the PC on which the system acts.

14. Automated system according to claim 13, wherein the computer-readable media (170) is arranged to interpret “sequential function chart” files.

15. Automated system according to claim 13, wherein it comprises interface circuits (55, 56, 57) connected between the shared data line (50) and the functional blocks to be controlled and comprising a microcontroller (75).

16. Automated system according to claim 13, wherein the system can be supplied a voltage of 12 volts convertible to 24 volts in order to be embedded in vehicles or boats or be able to operate at isolated sites.

17. Automated system according to claim 15, wherein at least one piece of firmware intended for the microcontrollers (75) of said interface circuits is loaded by the “jtag” pins of these microcontrollers.

18. Automated system according to claim 15, wherein the interface circuits comprise a base circuit (70) and a circuit (72) adapted to the block to be controlled.

19. Automated system according to claim 15, comprising a plurality of functional blocks intended to supply alarm signals, wherein interface circuits attached to alarm signal blocks are assigned the same address.

20. Automated system according to claim 15, wherein the base circuit (70) is formed of said microcontroller, a protocol converter (79) between the data sent by the bus and the data processable by said controller, and a voltage converter (77) for supplying the appropriate voltages to said blocks from the power provided by said shared line.
